(19) United States
(12) Patent Application Publication
(10) Pub. No.: US 2012/0328258 A1
(43) Pub. Date: Dec. 27, 2012

(54) FIBER OPTIC CASSETTE

(76) Inventors: David Lopez Barron, Reynosa (MX); Gabriela Medellin Ramos Clamont, Reynosa (MX); William Julius McPhil Giraud, Azle, TX (US)

(21) Appl. No.: 13/603,894

(22) Filed: Sep. 5, 2012

Related U.S. Application Data
(63) Continuation of application No. PCT/US11/27811, filed on Mar. 10, 2011.
(60) Provisional application No. 61/312,524, filed on Mar. 10, 2010.

(51) Int. Cl. G02B 6/46

(52) U.S. Cl. 385/135

(57) ABSTRACT

A fiber optic cassette having a housing having an interior, a component section and a front section is disclosed. A single splice holder, a mass splice holder and a pigtail cable assembly are positioned in the fiber optic component section. The pigtail cable assembly comprises a plurality of optical fibers, and is adapted to provide for at least one of the plurality of optical fibers to connect to one of the fiber optic adapters at a one end of the optical fibers. The pigtail cable assembly is modifiable to provide for the plurality of optical fibers to connect to one of a mass splice held by the mass splice holder and single fiber splices held by the single fiber splice holder at another end.

### RELATED APPLICATIONS

This application is a continuation of International Application No. PCT/US11/27811 filed Mar. 10, 2011, which claims the benefit of priority to U.S. Application No. 61/312,524, filed Mar. 10, 2010, both applications being incorporated herein by reference.

### BACKGROUND

1. Field of the Disclosure

The technology of the disclosure relates generally to fiber optic cassettes, and particularly to a fiber optic cassettes which may be used as a feeder module or a distribution module in fiber optic equipment.

2. Technical Background

Benefits of optical fiber use include extremely wide bandwidth and low noise operation. Because of these advantages, optical fiber is increasingly being used for a variety of applications, including but not limited to broadband voice, video, and data transmissions. Fiber optic networks employing optical fibers are being developed and used to deliver voice, video, and data transmissions to subscribers over both private and public networks. These fiber optic networks often include separated connection points at which it is necessary to link optical fibers in order to provide “live fiber” from one connection point to another connection point. In this regard, fiber optic equipment is located in data distribution centers or central offices to support interconnections.

The fiber optic equipment is customized based on application need. The fiber optic equipment is typically included in housings. The housing may be individually located cabinets or may be shelves or chassis in equipment racks for organizational purposes and to optimize use of space. One example of such fiber optic equipment is a fiber optic cassette or module. A fiber optic cassette is designed to provide cable-to-cable fiber optic connections and manage the polarity of fiber optic cable connections. A fiber optic cassette may be mounted in an enclosure or cabinet, or to a chassis or housing which is then mounted inside an equipment rack.

### SUMMARY OF THE DETAILED DESCRIPTION

Embodiments disclosed in the detailed description include a fiber optic cassette. The fiber optic cassette has a housing having an interior, a component section and a front section. The component section is positioned in the interior. A plurality of fiber optic adapters having an internal end and an external end are positioned through a panel face that separates the front section and the component section. A single splice holder is positioned in the fiber optic component section, wherein the single splice holder is adapted to hold a single fiber splice. A mass splice holder is positioned in the fiber optic component section, wherein the mass splice holder is adapted to hold a mass splice. A pigtail cable assembly is positioned in the fiber optic component section. The pigtail cable assembly comprises a plurality of optical fibers, and is adapted to provide for at least one of the plurality of optical fibers to connect to one of the fiber optic adapters at a one end of the optical fibers. The pigtail cable assembly is modifiable to provide for the plurality of optical fibers to connect to one of a mass splice held by the mass splice holder and single fiber splices held by the single fiber splice holder at another end.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is a diagram of an exemplary embodiment of a pigtail cable assembly having a mid-section, a first end section, a second end section and a sever site at the mid-section, wherein the mid-section is a fiber optic cable and the first end section and the second end section are individual separated optical fibers of the fiber optic cable;

FIG. 2 is a diagram of the pigtail cable assembly of FIG. 1 with the optical fibers of the second end section optically connected to other optical fibers via single fiber splices;

FIG. 3 is a diagram of the pigtail cable assembly of FIG. 1 with the second end section severed from the mid-section at the sever site and the fiber optic cable connected to another fiber optic cable via a mass splice;

FIG. 4 is an exemplary embodiment of a pigtail tail cable assembly including the pigtail cable assembly of FIG. 1 optically connected to a fiber optic cable via a mass splice and a plurality of separate optical fibers optically connected to other optical fibers via single fiber splices;

FIG. 5 is a top, perspective view of the inside of a cassette in which the pigtail cable assembly of FIG. 2 is positioned;

FIG. 6 is a top, perspective view of the inside of a cassette in which the pigtail cable assembly of FIG. 3 is positioned;

FIG. 7 is a top, perspective view of the inside of a cassette in which the pigtail cable assembly of FIG. 4 is positioned;

FIG. 8 is a diagram of cassettes located in a fiber optic enclosure;

FIG. 9 shows a schematic representation (not to scale) of the refractive index profile of a cross-section of the glass portion of an exemplary embodiment of a multimode optical fiber disclosed herein wherein the depressed-index annular portion is offset from the core and is surrounded by an outer annular portion; and

FIG. 10 is a schematic representation (not to scale) of a cross-sectional view of the optical waveguide fiber of FIG. 9.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed in the detailed description include a fiber optic cassette. The fiber optic cassette has a housing having an interior, a component section and a front section. The component section is positioned in the interior. A plurality of fiber optic adapters having an internal end and an external end are positioned through a panel face that separates the front section and the component section. A single splice holder is positioned in the fiber optic component section, wherein the single splice holder is adapted to hold a single fiber splice. A mass splice holder is positioned in the fiber optic component section, wherein the mass splice holder is adapted to hold a mass splice. A pigtail cable assembly is positioned in the fiber optic component section. The pigtail cable assembly comprises a plurality of optical fibers, and is adapted to provide for at least one of the plurality of optical fibers to connect to one of the fiber optic adapters at a one end of the optical fibers. The pigtail cable assembly is modifiable to provide for the plurality of optical fibers to connect to one of a mass splice held by the mass splice holder and single fiber splices held by the single fiber splice holder at another end.

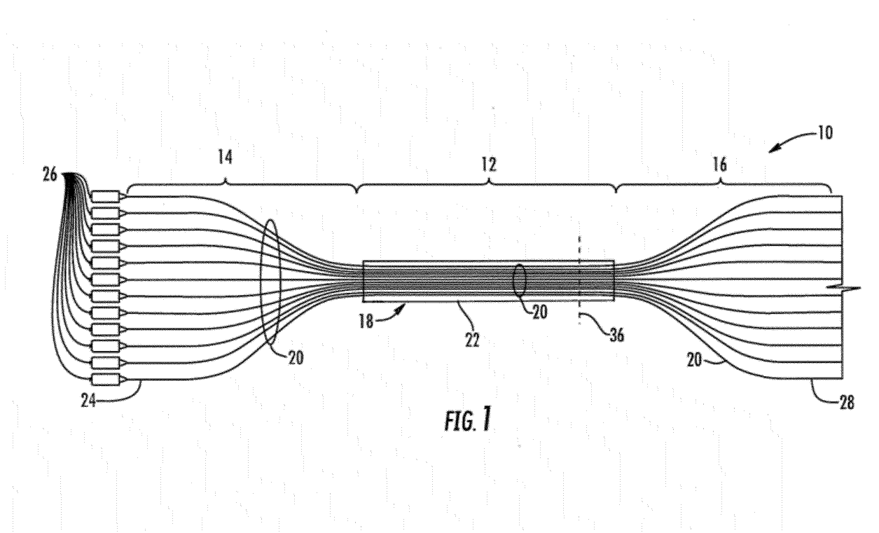

In this regard, a pigtail cable assembly 10 according to an exemplary embodiment is illustrated in FIG. 1. The pigtail cable assembly 10 is a type of a hybrid fiber optic pigtail assembly allowing for single fiber and mass fiber connections and splicing with the need of a furcation piece or body. The pigtail cable assembly 10 has a mid-section 12, a first end section 14 and a second end section 16. The mid-section 12 may be in the form of a fiber optic cable 18 having a plurality of optical fibers 20. As an example, the fiber optic cable 18 may be a ribbon cable with the optical fibers 20 encased in a plastic matrix 22. When the matrix 22 is removed the individual optical fibers 20 may be severed. In this way, the pigtail cable assembly 10 is modifiable. This is illustrated in FIG. 1 at the first end section 14 and at the second end section 16, where the matrix 22 has been removed and the individual optical fibers 20, each having a fiber coating, are allowed to separate and route individually. The fiber optic cable 18 in FIG. 1 is shown as having 12 optical fibers 20. However, the pigtail cable assembly 10 may have any number of optical fibers 20. As non-limiting examples, the pigtail cable assembly may have two, six, eight, 16, 24 or 36 optical fibers 20. Additionally, the fiber coating of each of the optical fibers 20 may be color-coded. In FIG. 1, the color-coding is shown for the 12 optical fibers 20 of the pigtail cable assembly 10. In one embodiment, the optical fibers 20 may be color-coded in a 12 color sequence of blue, orange, green, brown, slate, white, red, black, yellow, purple, rose, and aqua. The individual optical fibers with the fiber coating and the color-coding may be about 250 μm in diameter.

A first end 24 of the optical fibers 20 at the first end section 14 is connectorized with fiber optic connectors 26, and therefore, adapted to be connected to a fiber optic adapted. One or more of the first ends 24 may be received in one end of a fiber optic adapter (not shown in FIG. 1) where the optical fiber 20 can optically connect to another optical fiber received by the other end of the fiber optic adapter. The fiber optic connectors may be any type. For instance, the connector type may include SC, LC, FC, or the like. At the second end section 16, second ends 28 of the optical fibers 20 are not connectorized. In this way, one or more of the second ends 28 may be adapted to be individually spliced to other optical fibers or to other fiber optic components, for example, a splitter (not shown in FIG. 1). The pigtail cable assembly 10 may be any overall length with the mid-section 12, the first end section 14 and the second end section 16 being any lengths. As a non-limiting example, the mid-section 12 may be about 24 inches, the first end section 14 may be about 12 inches and the second end section 16 may be about 24 inches, for an overall pigtail cable assembly 10 length of 60 inches.

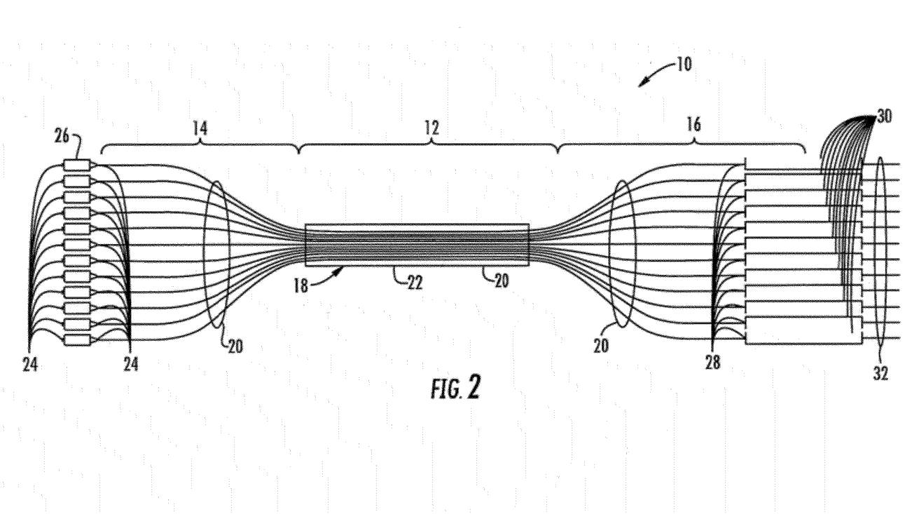

In FIG. 2, each of the second ends 28 of the optical fibers 20 are shown terminated at a single fiber splice 30. In this manner, the optical fibers 20 may be adapted to be spliced to other optical fibers 32 to establish optical connection between optical fibers 20 and optical fibers 32. The splice may be a mechanical splice or a fusion splice. Any suitable mechanical splice may be used such as those available under the tradename UniCam® from Corning Cable Systems LLC of Hickory, N.C., but other suitable mechanical splice assemblies are possible.

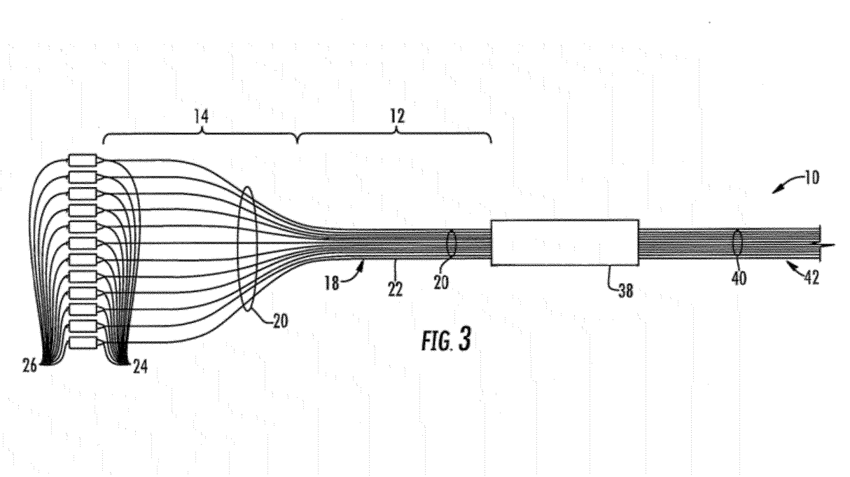

Alternatively or additionally, the second end section 16 may be severed from the mid-section 12 at a sever site 34. The sever site 34 may be at any position along the length of the fiber optic cable 18 in the mid-section 12. In the case of the fiber optic cable 18 being a ribbon cable, the sever site may be in the mid-section 12 where the matrix 22 remains on the ribbon cable, i.e. has not been removed. Severing the second end section 16 from the mid-section 12 may be accomplished by any suitable means for severing the fiber optic cable 18, for example by cutting. After the second end section 16 is severed from the mid-section 12, the mid-section 12 may be terminated at a mass splice 38 as shown in FIG. 3. In other words, the mid-section 12 of the fiber optic cable 18 may be adapted to be connected to a mass splice at a sever point. The mass splice 38 may be any type of multi-cable splice including a mechanical splice or a mass fusion splice to splice the optical fibers 20 fiber optic cable 18 to optical fibers 40 of another fiber optic cable 42.

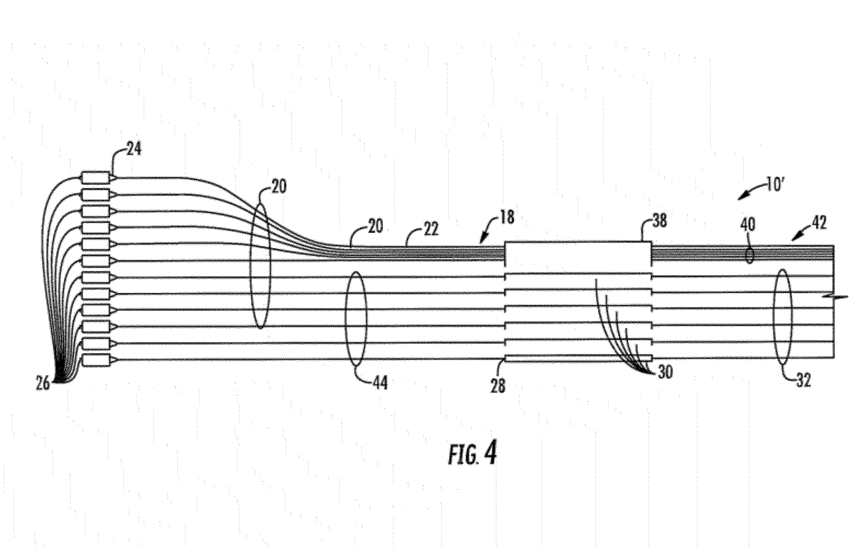

Referring now to FIG. 4, there is illustrated another embodiment of a pigtail cable assembly 10′ which is provided to show an embodiment that includes both a fiber optic cable and individual optical fibers in another form of a hybrid fiber optic pigtail assembly. The pigtail cable assembly 10′ is shown comprising a fiber optic cable 18, shown as a ribbon cable, terminated at a mass splice 38 to optical fibers 40 of another fiber optic cable 42, and with optical fibers 20 terminated with fiber optic connectors 26 at a first end 24 as described with respect to FIG. 3. Additionally, a plurality of single connectorized optical fibers 44 each terminated with fiber optic connectors 26 at the first end 24. The second ends 28 of the optical fibers 20 are shown terminated at a single fiber splice 30 for splicing to other optical fibers 32 to establish optical connection between optical fibers 20 and optical fibers 32 as discussed above with respect to FIG. 2.

The pigtail cable assembly 10, 10′ may be installed in fiber optic equipment, including, an enclosure, cassette, module, shelf, or the like. For purposes of facilitating discussion of the embodiments, the term “cassette” will be used, but it should be understood that any type of fiber optic equipment is contemplated by the embodiments. The cassette 50 may mount or position in other fiber optic equipment, including, but not limited to, a cabinet, enclosure, local connection point, fiber distribution hub, or the like.

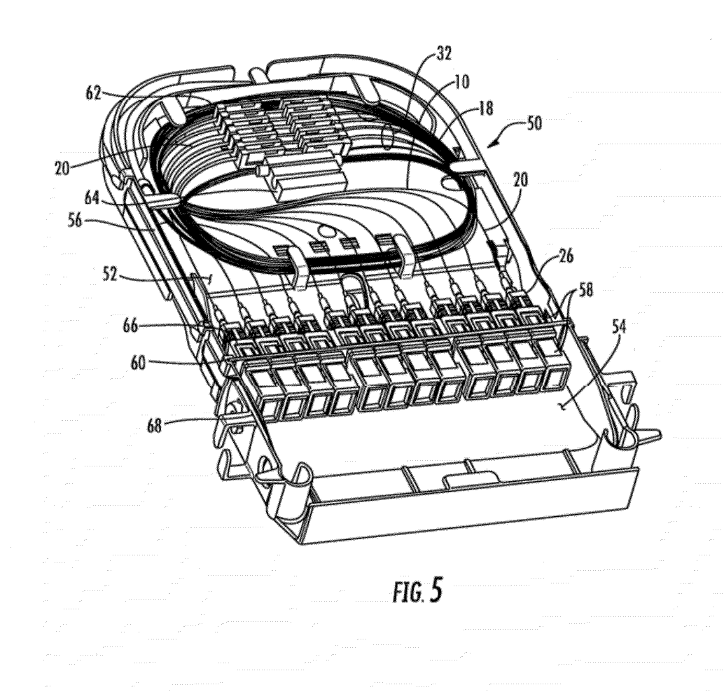

In this regard, FIGS. 5-7 illustrate embodiments of the pigtail cable assembly 10, 10′ in a cassette 50. The cassette 50 has an interior 52, a front section 54 and a component section 56. Fiber optic adapters 58 mount through apertures in a face panel 60. The face panel 60 is positioned at the interface between the front section 52 and the component section 56 and acts to separate the front section 52 from the component section 56. Single fiber splice holder 62 and mass splice holder 64 position in the interior 52 in the component section 56. In FIGS. 5-7, the single splice holder 62 is shown as being able to hold twelve single fiber splices, two per section. However, the single splice holder 62 may hold any number of single splices. Similarly, the mass splice holder 64 is shown as being able to hold two mass splices, but the mass splice holder 64 may hold any number of mass splices.

Referring now to FIG. 5, the pigtail cable assembly 10 illustrated in FIG. 2 is shown positioned in the cassette 50. The optical fibers 20 route to the fiber optic adapters 58. The fiber optic adapters 58 receive the fiber optic connectors 26 at the ends 24 of the optical fibers 20 of the first end section 14. The fiber optic connectors 26 insert into an internal end 66 of the fiber optic adapters 58. Although not shown in FIG. 5, the fiber optic adapters 58 may also receive other connectorized optical fibers which would insert into an external end 68 of the fiber optic adapters 58. In this manner, an optical connection may be established between the optical fiber 20 and the other optical fiber received by the same fiber optic adapter 58.

The fiber optic cable 18, routes in the interior 56 in a manner to provide slack and other management of the fiber optic cable 18 and to facilitate the positioning of the optical fibers 20 of the second end section 16 for connection and/or termination at the one end of the single fiber splices 30 positioned in the single fiber splice holder 62. The optical fiber 20 may then be spliced to optical fiber 32 connected to the other end of the single fiber splice 30. Although not shown in FIG. 5, the optical fibers 32 may then route out of the cassette 50 to other optical components.

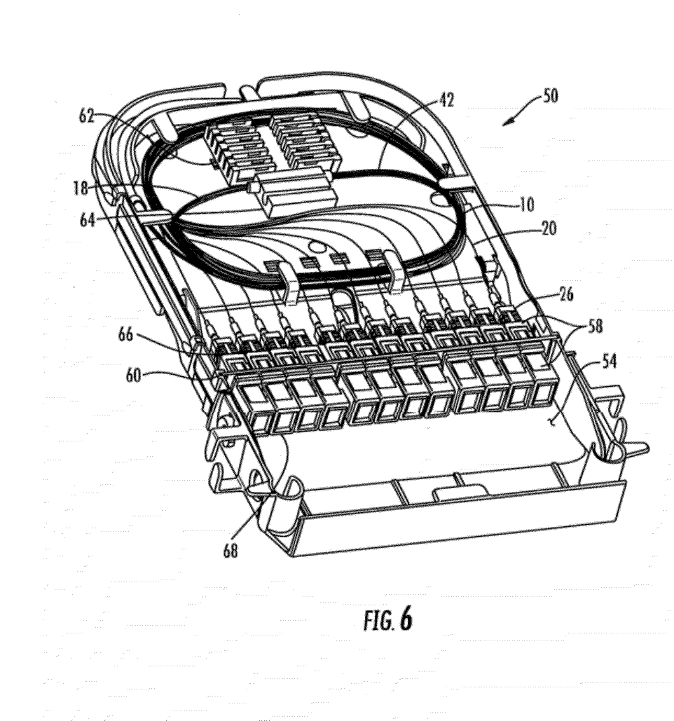

Referring now to FIG. 6, the pigtail cable assembly 10 illustrated in FIG. 3 is shown positioned in the cassette 50. The connection of the optical fibers 20 of the first end section 14 to the fiber optic adapters 58 is similar to that described with respect to FIG. 4, and, therefore will not be repeated here. In FIG. 5, the fiber optic cable 18 was severed at sever point 36 (not shown in FIG. 5) and, therefore, pigtail cable assembly 10 does not include a second end section 16. Instead, the fiber optic cable 18 routes to a mass splice holder 64 having a mass splice 38 positioned therein. The fiber optic cable 18 connects to and/or terminates at one end of the mass splice 38 and optically connects to another fiber optic cable 42 connects to and/or terminated at the other end of the mass splice 38. Although not shown in FIG. 6, the fiber optic cable 42 may then route out of the cassette 50 to other optical components.

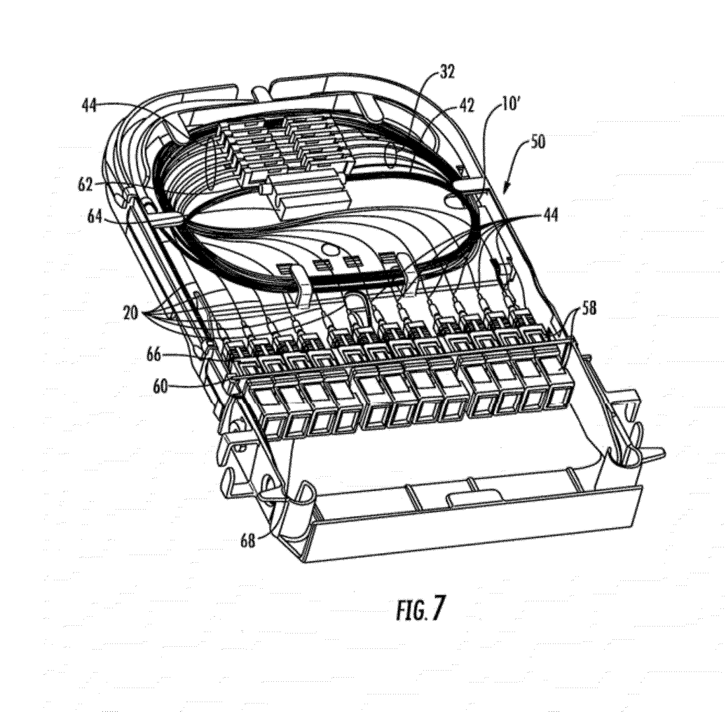

FIG. 7 illustrated the pigtail cable assembly 10′ of FIG. 4 in a cassette 50. As discussed with respect to FIG. 4, the pigtail cable assembly 10′ includes a fiber optic cable 18 having optical fibers 20 and individual separate optical fibers 44. Both the optical fibers 20 and the optical fibers 44 are connectorized having a fiber optic connector 26 on their first end 24. The connection of the optical fibers 20 and the optical fibers 44 to the fiber optic adapters 58 is similar to that described above, and, therefore will not be repeated here. However, the embodiment illustrated in FIG. 7, includes the fiber optic cable 18 connecting to and/or terminating at the mass splice 38 in the mass fiber splice holder 64, and the individual optical fibers 44 connecting to and/or terminating at the single fiber splices 30 at the single fiber splice holder 62.

Any number of fiber optic cables 18 and optical fibers 20, 44 may be positioned in the cassette 50. Additionally, any number of single fiber splice holders 62 holding any number of single fiber splices 30 may be positioned in the component section 56 of the cassette 50. Similarly, any number of mass splice holders 64 holding any number of mass splices 38 may be positioned in the component section 56 of the cassette 50. Further, the cassette 50 may have one design and be used as a feeder cassette or a distribution cassette depending on whether the pigtail cable assembly 10 provides for mass splicing of the fiber optic cable 18, for example a ribbon cable, or individual splicing of the optical fibers. In other words, only one pigtail cable assembly 10 has to be provided and, whether a feeder cassette or a distribution cassette is needed, the second end section 16 may be severed or not severed at the sever point 36. Severing the second end section 16 can be performed at the factory or in the field.

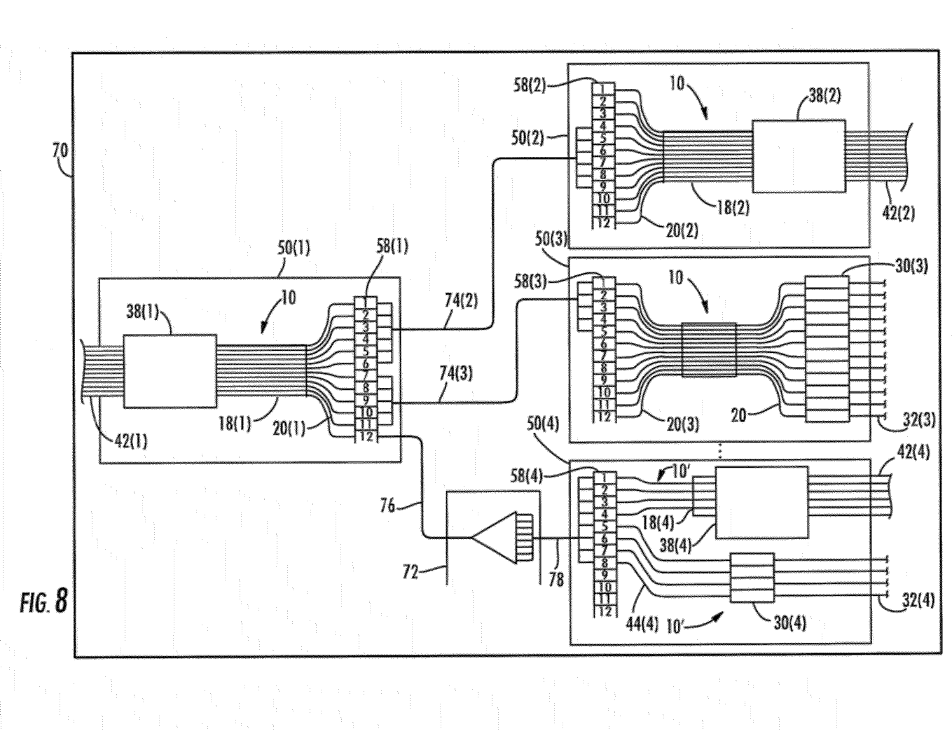

FIG. 8 illustrates exemplary embodiments of ways in which the cassettes 50 may be used as both feeder cassettes and distribution cassettes. FIG. 8 is not intended to be inclusive and/or limiting of all the different ways the cassette 50 may be utilized and, accordingly, there are other ways and/or configurations for utilizing the cassette 50. The embodiment illustrated in FIG. 8 shows four cassettes 50(1), 50(2), 50(3) and 50(4) and an optical splitter 72 in an enclosure 70. The enclosure 70 may be any type or style of enclosure, cabinet, shelf, tray, housing, closure and the like. As non-limiting examples, the enclosure 70 may be a local convergence point, a fiber distribution hub, or any type of an optical terminal. The cassettes 50(1) and 50(2) include the pigtail cable assembly 10 configured as shown in FIGS. 3 and 6

The cassette 50(1) may be used as a feeder cassette receiving a feeder cable shown as the fiber optic cable 42(1). The fiber optic cable 42(1) may be a twelve fiber ribbon cable which is spliced to the fiber optic cable 18(1), which may also be a twelve (12) fiber ribbon cable. The fiber optic cable 42(1) is spliced to the fiber optic cable 18(1) by mass splice 38(1). The individual optical fibers 20(1) separate and connect to the internal ends of respective fiber optic adapters 58(1) in the cassette 50(1). Optical fibers 74(2) and 74(3), which may be in the form of individual jumpers or jumpers in a fiber optic cable, connect at one end to the external ends of the fiber optic adapters 58(1) to establish an optical connection between the optical fibers 20(1) and the optical fibers 74(2) and 74(3). Six optical fibers 20(1) optically connect to six optical fibers 74(2), and five optical fibers 20(1) optically connect to five optical fibers 74(3). In FIG. 8, the optical fibers 74(2) and 74(3) are shown routed to cassettes 50(2) and 50(3), respectively. One optical fiber 20(1) optically connects to a single optical fiber 76 and routes to optical splitter 72.

The six optical fibers 74(2) route to cassette 50(2) and connect to the external ends of fiber optic adapters 58(2) in cassette 50(2). In FIG. 8, the six optical fibers 74(2) are shown connected to fiber optic adapters 58(2) numbers 4, 5, 6, 7, and 8. Twelve optical fibers 20(2) from fiber optic cable 18(2) which may be a 12 fiber ribbon cable connect to the internal ends of the fiber optic adapters 58(2). In this way, optical connection is established between the six optical fibers 74(2) and six of the optical fibers of the 12 optical fibers 20(2) connected to the internal ends of the fiber optic adapters 58(2), numbers 4, 5, 6, 7 and 8. The six optical fibers 20(2) connected fiber optic adapters 58(2) numbers 1, 2, 3, 10, 11 and 12 are not optically connected to any fibers at the fiber optic adapters 58(2) and, therefore, may not be carrying any optical signal. The fiber optic cable 18(2) may be spliced to another fiber optic cable 42(2) by or via mass splice which may be another feeder cable or a distribution cable.

The five optical fibers 74(3) route to cassette 50(3) and connect to the external ends of fiber optic adapters 58(3) in cassette 50(3). In FIG. 8, the cassette 50(3) includes the pigtail cable assembly 10 configured as shown in FIGS. 2 and 5. The five optical fibers 74(3) are shown connected to fiber optic adapters 58(3) numbers 1, 2, 3, 4 and 5. Twelve optical fibers 20(3) from fiber optic cable 18(3) which may be a 12 fiber ribbon cable connect to the internal ends of the fiber optic adapters 58(2). In this way, optical connection is established between the five optical fibers 74(3) and five of the optical fibers of the 12 optical fibers 20(3) connected to the internal ends of the fiber optic adapters 58(3), numbers 1, 2, 3, 4 and 5. The seven optical fibers 20(3) connected fiber optic adapters 58(3) numbers 6, 7, 8, 9, 10, 11 and 12 are not optically connected to any fibers at the fiber optic adapters 58(3) and, therefore, may not be carrying any optical signal. The individual optical fibers 20(3) of the fiber optic cable 18(3) may be spliced to the optical fibers of another fiber optic cable 32(3) by or via single fiber splices 30(3). The optical fibers 32(3) may be distribution cables for routing to subscriber premises, as an example.

The single optical fiber 76 routes to the optical splitter 72, which in FIG. 8 is shown as a 1×8 optical splitter. The single optical fiber 76 may be a single fiber pigtail. The optical splitter 72 splits the optical signal carries by the single optical fiber 76 into 8 optical signals each carried by a separate optical fiber 78, thereby being 8 optical fibers 78. The optical fibers 78 may be single fiber pigtails or multi-fiber cable pigtails. The optical fibers 78 route to cassette 50(4) and connect to the external ends of fiber optic adapters 58(4) in cassette 50(4). In FIG. 8, the cassette 50(4) includes the pigtail cable assembly 10′ configured as shown in FIGS. 4 and 7. The eight optical fibers 78 are shown connected to fiber optic adapters 58(4) numbers 1, 2, 3, 4, 5, 6, 7 and 8. Four optical fibers 20(4) from fiber optic cable 18(4) which may be a 4 fiber ribbon cable connect to the internal ends of the fiber optic adapters 58(4), numbers 1, 2, 3 and 4. In this way, optical connection is established between the four of the optical fibers 78 and the four optical fibers 20(4) of the fiber optic cable 18(4). The fiber optic cable 18(4) may be spliced to another fiber optic cable 42(4) by or via mass splice 38(4) which may be a distribution cable. Four individual optical fibers 44(4) connect to the internal ends of the fiber optic adapters 58(4), numbers 5, 6, 7 and 8. In this way, optical connection is established between the other four of the optical fibers 78 and the four optical fibers 44(4) of the fiber optic cable 18(4). The individual optical fibers 44(4) may be spliced to the optical fibers of another fiber optic cable 32(4) by or via a single fiber splices 30(4). The optical fibers 32(4) may be distribution cables for routing to subscriber premises, as an example.

The enclosure 70 may include other fiber optic components for example, without limitation, additional splitters, CWDM, WDM, feeder terminal blocks, distribution terminal blocks, fiber and cable routing guides, and strain relief devices, to name just a few.

Further, as used herein, it is intended that terms “fiber optic cables” and/or “optical fibers” include all types of single mode and multi-mode light waveguides, including one or more bare optical fibers, loose-tube optical fibers, tight-buffered optical fibers, ribbonized optical fibers, bend-insensitive optical fibers, or any other expedient of a medium for transmitting light signals. An example of a bend-insensitive, or bend resistant, optical fiber is ClearCurve® optical fiber, manufactured by Corning Incorporated. Suitable fibers of this type are disclosed, for example, in U.S. Patent Application Publication Nos. 2008/0166094 and 2009/0169163.

Bend resistant multimode optical fibers may comprise a graded-index core region and a cladding region surrounding and directly adjacent to the core region, the cladding region comprising a depressed-index annular portion comprising a depressed relative refractive index relative to another portion of the cladding. The depressed-index annular portion of the cladding is preferably spaced apart from the core. Preferably, the refractive index profile of the core has a parabolic or substantially curved shape. The depressed-index annular portion may, for example, comprise a) glass comprising a plurality of voids, or b) glass doped with one or more downdopants such as fluorine, boron, individually or mixtures thereof. The depressed-index annular portion may have a refractive index delta less than about −0.2% and a width of at least about 1 micron, said depressed-index annular portion being spaced from said core by at least about 0.5 microns.

In some embodiments that comprise a cladding with voids, the voids in some preferred embodiments are non-periodically located within the depressed-index annular portion. By “non-periodically located” we mean that when one takes a cross section (such as a cross section perpendicular to the longitudinal axis) of the optical fiber, the non-periodically disposed voids are randomly or non-periodically distributed across a portion of the fiber (e.g. within the depressed-index annular region). Similar cross sections taken at different points along the length of the fiber will reveal different randomly distributed cross-sectional hole patterns, i.e., various cross sections will have different hole patterns, wherein the distributions of voids and sizes of voids do not exactly match for each such cross section. That is, the voids are non-periodic, i.e., they are not periodically disposed within the fiber structure. These voids are stretched (elongated) along the length (i.e. generally parallel to the longitudinal axis) of the optical fiber, but do not extend the entire length of the entire fiber for typical lengths of transmission fiber. It is believed that the voids extend along the length of the fiber a distance less than about 20 meters, more preferably less than about 10 meters, even more preferably less than about 5 meters, and in some embodiments less than 1 meter.

The multimode optical fiber disclosed herein exhibits very low bend induced attenuation, in particular very low macrobending induced attenuation. In some embodiments, high bandwidth is provided by low maximum relative refractive index in the core, and low bend losses are also provided. Consequently, the multimode optical fiber may comprise a graded index glass core; and an inner cladding surrounding and in contact with the core, and a second cladding comprising a depressed-index annular portion surrounding the inner cladding, said depressed-index annular portion having a refractive index delta less than about −0.2% and a width of at least 1 micron, wherein the width of said inner cladding is at least about 0.5 microns and the fiber further exhibits a 1 turn, 10 mm diameter mandrel wrap attenuation increase of less than or equal to about 0.4 dB/turn at 850 nm, a numerical aperture of greater than 0.14, more preferably greater than 0.17, even more preferably greater than 0.18, and most preferably greater than 0.185, and an overfilled bandwidth greater than 1.5 GHz-km at 850 nm.

50 micron diameter core multimode fibers can be made which provide (a) an overfilled (OFL) bandwidth of greater than 1.5 GHz-km, more preferably greater than 2.0 GHz-km, even more preferably greater than 3.0 GHz-km, and most preferably greater than 4.0 GHz-km at an 850 nm wavelength. These high bandwidths can be achieved while still maintaining a 1 turn, 10 mm diameter mandrel wrap attenuation increase at an 850 nm wavelength of less than 0.5 dB, more preferably less than 0.3 dB, even more preferably less than 0.2 dB, and most preferably less than 0.15 dB. These high bandwidths can also be achieved while also maintaining a 1 turn, 20 mm diameter mandrel wrap attenuation increase at an 850 nm wavelength of less than 0.2 dB, more preferably less than 0.1 dB, and most preferably less than 0.05 dB, and a 1 turn, 15 mm diameter mandrel wrap attenuation increase at an 850 nm wavelength, of less than 0.2 dB, preferably less than 0.1 dB, and more preferably less than 0.05 dB. Such fibers are further capable of providing a numerical aperture (NA) greater than 0.17, more preferably greater than 0.18, and most preferably greater than 0.185. Such fibers are further simultaneously capable of exhibiting an OFL bandwidth at 1300 nm which is greater than about 500 MHz-km, more preferably greater than about 600 MHz-km, even more preferably greater than about 700 MHz-km. Such fibers are further simultaneously capable of exhibiting minimum calculated effective modal bandwidth (Min EMBc) bandwidth of greater than about 1.5 MHz-km, more preferably greater than about 1.8 MHz-km and most preferably greater than about 2.0 MHz-km at 850 nm.

Preferably, the multimode optical fiber disclosed herein exhibits a spectral attenuation of less than 3 dB/km at 850 nm, preferably less than 2.5 dB/km at 850 nm, even more preferably less than 2.4 dB/km at 850 nm and still more preferably less than 2.3 dB/km at 850 nm. Preferably, the multimode optical fiber disclosed herein exhibits a spectral attenuation of less than 1.0 dB/km at 1300 nm, preferably less than 0.8 dB/km at 1300 nm, even more preferably less than 0.6 dB/km at 1300 nm.

In some embodiments, the numerical aperture (“NA”) of the optical fiber is preferably less than 0.23 and greater than 0.17, more preferably greater than 0.18, and most preferably less than 0.215 and greater than 0.185.

In some embodiments, the core extends radially outwardly from the centerline to a radius R1, wherein 10<R1<40 microns, more preferably 20<R1<40 microns. In some embodiments, 22<R1<34 microns. In some preferred embodiments, the outer radius of the core is between about 22 to 28 microns. In some other preferred embodiments, the outer radius of the core is between about 28 to 34 microns.

In some embodiments, the core has a maximum relative refractive index, less than or equal to 1.2% and greater than 0.5%, more preferably greater than 0.8%. In other embodiments, the core has a maximum relative refractive index, less than or equal to 1.1% and greater than 0.9%.

In some embodiments, the optical fiber exhibits a 1 turn, 10 mm diameter mandrel attenuation increase of no more than 1.0 dB, preferably no more than 0.6 dB, more preferably no more than 0.4 dB, even more preferably no more than 0.2 dB, and still more preferably no more than 0.1 dB, at all wavelengths between 800 and 1400 nm.

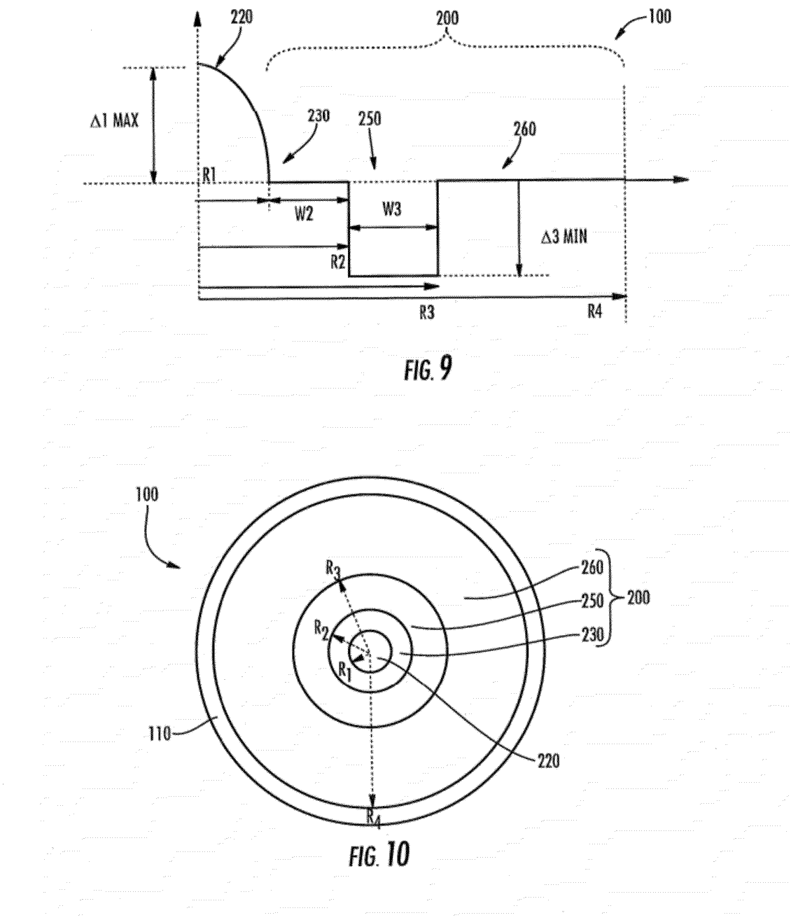

FIG. 9 shows a schematic representation of the refractive index profile of a cross-section of the glass portion of an exemplary embodiment of a multimode optical fiber 100 comprising a glass core 220 and a glass cladding 200, the cladding comprising an inner annular portion 230, a depressed-index annular portion 250, and an outer annular portion 260. FIG. 10 is a schematic representation (not to scale) of a cross-sectional view of the optical waveguide fiber of FIG. 9. The core 220 has outer radius R1 and maximum refractive index delta Δ1MAX. The inner annular portion 230 has width W2 and outer radius R2. Depressed-index annular portion 250 has minimum refractive index delta percent Δ3MIN, width W3 and outer radius R3. The depressed-index annular portion 250 is shown offset, or spaced away, from the core 220 by the inner annular portion 230. The annular portion 250 surrounds and contacts the inner annular portion 230. The outer annular portion 260 surrounds and contacts the annular portion 250. The clad layer 200 is surrounded by at least one coating 110, which may in some embodiments comprise a low modulus primary coating and a high modulus secondary coating.

The inner annular portion 230 has a refractive index profile Δ2(r) with a maximum relative refractive index Δ2MAX, and a minimum relative refractive index Δ2MIN, where in some embodiments Δ2MAX=Δ2MIN. The depressed-index annular portion 250 has a refractive index profile Δ3(r) with a minimum relative refractive index Δ3MIN. The outer annular portion 260 has a refractive index profile Δ4(r) with a maximum relative refractive index Δ4MAX, and a minimum relative refractive index Δ4MIN, where in some embodiments Δ4MAX=Δ4MIN. Preferably, Δ1MAX>Δ2MAX>Δ3MIN. In some embodiments, the inner annular portion 230 has a substantially constant refractive index profile, as shown in FIG. 9 with a constant Δ2(r); in some of these embodiments, Δ2(r)=0%. In some embodiments, the outer annular portion 260 has a substantially constant refractive index profile, as shown in FIG. 9 with a constant Δ4(r); in some of these embodiments, Δ4(r)=0%. The core 220 has an entirely positive refractive index profile, where Δ1(r)>0%. R1 is defined as the radius at which the refractive index delta of the core first reaches value of 0.05%, going radially outwardly from the centerline. Preferably, the core 220 contains substantially no fluorine, and more preferably the core 220 contains no fluorine. In some embodiments, the inner annular portion 230 preferably has a relative refractive index profile Δ2(r) having a maximum absolute magnitude less than 0.05%, and Δ2MAX<0.05% and Δ2MIN>−0.05%, and the depressed-index annular portion 250 begins where the relative refractive index of the cladding first reaches a value of less than −0.05%, going radially outwardly from the centerline. In some embodiments, the outer annular portion 260 has a relative refractive index profile Δ4(r) having a maximum absolute magnitude less than 0.05%, and Δ4MAX<0.05% and Δ4MIN>−0.05%, and the depressed-index annular portion 350 ends where the relative refractive index of the cladding first reaches a value of greater than −0.05%, going radially outwardly from the radius where Δ3MIN is found.

Many modifications and other embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims.

It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A fiber optic cassette, comprising:
a housing having a plurality of fiber optic adapters and a component section;
a splice holder positioned in the fiber optic component section, wherein the splice holder is adapted to hold one of a single fiber splice and a mass splice; and
a pigtail cable assembly positioned in the housing, wherein the pigtail cable assembly comprises a plurality of optical fibers, and wherein the pigtail cable assembly is adapted to provide for at least one of the plurality of optical fibers to connect to one of the fiber optic adapters at one end, and wherein the pigtail cable assembly is modifiable to provide for the plurality of optical fibers to connect to one of a mass splice held by the mass splice holder and single fiber splices held by the single splice holder at another end.

2. The fiber optic cassette of claim 1, wherein the splice holder comprises a single fiber splice holder and a mass splice holder.

3. The fiber optic cassette of claim 1, wherein the single fiber splice holder is adapted to hold a plurality of single fiber splices.

4. The fiber optic cassette of claim 1, wherein the mass splice holder is adapted to hold a plurality of mass splices.

5. The fiber optic cassette of claim 1, wherein the fiber optic cassette is adapted for use as one or both of a feeder cassette and a distribution cassette.

6. The fiber optic cassette of claim 1, further comprising other fiber optic components positioned in the fiber optic component section.

7. The fiber optic cassette of claim 6, wherein the other fiber optic components comprises an optical splitter.

8. The fiber optic cassette of claim 6, wherein the other fiber optic components comprises a wave division multiplexer.

9. The fiber optic cassette of claim 6, wherein the other fiber optic components comprises a coarse wave division multiplexer.

10. The fiber optic cassette of claim 1, wherein the optical fibers comprise bend-insensitive optical fibers.

11. A fiber optic cassette, comprising:
a housing having an interior, a component section and a front section, wherein the component section is positioned in the interior;
a plurality of fiber optic adapters each of the plurality of fiber optic adapters having an internal end and an external end;
a single splice holder positioned in the fiber optic component section, wherein the single splice holder is adapted to hold a single fiber splice;
a mass splice holder positioned in the fiber optic component section, wherein the mass splice holder is adapted to hold a mass splice; and
a pigtail cable assembly positioned in the fiber optic component section, wherein the pigtail cable assembly comprises a plurality of optical fibers, and wherein the pigtail cable assembly is adapted to provide for at least one of the plurality of optical fibers to connect to one of the fiber optic adapters at a one end of the optical fibers, and wherein the pigtail cable assembly is modifiable to provide for the plurality of optical fibers to connect to one of a mass splice held by the mass splice holder and single fiber splices held by the single fiber splice holder at another end.

12. The fiber optic cassette of claim 11, wherein the single fiber splice holder is adapted to hold a plurality of single fiber splices.

13. The fiber optic cassette of claim 11, wherein the mass splice holder is adapted to hold a plurality of mass splices.

14. The fiber optic cassette of claim 11, wherein the fiber optic cassette is adapted for use as one or both of a feeder cassette and a distribution cassette.

15. The fiber optic cassette of claim 11, wherein the optical fibers comprise bend-insensitive optical fibers.

16. A fiber optic assembly, comprising:
an enclosure;
a first fiber optic cassette adapted for use as a feeder cassette mounted in the enclosure and having fiber optic adapters and a first pigtail cable assembly positioned therein; and
a second fiber optic cassette adapted for use as a distribution cassette mounted in the enclosure and fiber optic adapters having a second pigtail cable assembly positioned therein,
wherein at least one of the first pigtail cable assembly and the second pigtail cable assembly comprises a plurality of optical fibers, and wherein at least one of the first pigtail cable assembly and the second pigtail cable assembly is adapted to provide for at least one of the plurality of optical fibers to connect to one of the fiber optic adapters at a one end of the optical fibers, and wherein the at least one of the first pigtail cable assembly and the second pigtail cable assembly is modifiable to provide for the plurality of optical fibers to connect to one of a mass splice held by the mass splice holder and single fiber splices held by the single fiber splice holder at another end.

17. The fiber optic assembly of claim 16, further comprising a fiber optic component.

18. The fiber optic assembly of claim 17, wherein the fiber optic component comprises an optical splitter.

19. The fiber optic assembly of claim 17, wherein the fiber optic component comprises a wave division multiplexer.

20. The fiber optic assembly of claim 17, wherein the fiber optic component comprises a coarse wave division multiplexer.
